(19) United States
(12) Patent Application Publication
(10) Pub. No.: US 2007/0073198 A1
(43) Pub. Date: Mar. 29, 2007

(54) Monolight massage system

(76) Inventor: Vlash Koljaka, Naples, FL (US)

Correspondence Address: Vlash Koljaka, 6068 Nuntington Woods Dr, Naples, FL, 34112-2981, US

(21) Appl. No.: 11/178,780

(22) Filed: Jul. 12, 2005

(51) Int. Cl. A61H 1/00

(52) U.S. Cl. 601/15; 601/DIG. 5

(57) ABSTRACT

A monolight hand-held massage device that includes a multiple of LED light bulbs which can be directed to any part of a human body. The device is constructed in different geometric shapes. The device uses a single wave length monochromatic red light of 660 nanometer pulsating at 266 times per second. This kind of light is known for it's excellent therapeutic effects on afflicted cell tissues. The impulses of the pulsating light can be interrupted and the length of the interruptions can be controlled at a rate between 200 to 1100 microseconds.

### FIELD OF THE INVENTION

There are many different massage systems and techniques that are used on the human body. There are body massages that include the use of the hands and/or vibratory devices. The vibratory devices are either hand held or are attached to the body. The vibratory devices can also be a chair for a person to sit on while receiving a massage or it can be a mattress having sections that are vibrating.

### BACKGROUND OF THE INVENTION

There are no known electronic or monolight massage systems that effectively deliver a massage impulse over a greater effected area. The only electronic device on the market is known under the name of “Chi Lite”. It is advertised or described as an acupuncture point stimulator that provides a light beam that can either be applied directly to the skin, where it will penetrate approximately one inch into soft tissues, or for deeper penetration into the body. A single wavelength monochromatic light beam will travel through the body's acupuncture meridian channels, like fiber optics, to reach internal areas within the body. The described light also acts as an extremely effective acupuncture point stimulator device. The description continues to state that it is important to note that the light is not doing the healing. Rather, it is providing the necessary energy to the cells, specifically to the DNA molecules in the cells and the cells perform their own natural repair process.

In Europe, during the 1960's, it was discovered that certain monochromatic single wavelength light beams had excellent therapeutic effects on afflicted cell tissues. This occurs through a process called “Photostimulation”. Various single wavelengths in the red and infrared color spectrums (630 nanometers to 950 nanometers) have been used extensively because they fall within the cellular frequency ranges of biological tissue.

However, one of the most widely used is the 660 nanometer red wavelength, because it is closer to the actual frequency of a healthy cell. A single light wave is essential because the cell will not respond to any treatment if more than one wavelength is present.

The DNA in cells appears to respond much more quickly to a single frequency of light. It seems that the DNA, when it is deprived of or overloaded with energy. would prefer to communicate with or to respond to only one frequency at a time.

It is also known that when monochromatic light pulses with certain cycles per second are applied, it allows a deeper penetration into problem cells. It can reach virtually any spot within the human body with light and can be used in places that traditional acupuncture can not.

### BRIEF DESCRIPTION OF THE INVENTION

With the above descriptions in mind the inventive concept has been extended into devices of different sizes to be applied to different areas of the body. Each of the devices has a multiple of lights arranged in one plane. This way, a greater area of cells can be treated at the same time. This removes the arduous task of finding one or more afflicted cells as is the practice in acupuncture. The lights consist of LED light bulbs (Light Emitting Diodes). All the lights pulse at a certain wavelength and for a certain duration at the time.

### BRIEF DESCRIPTION OF THE DRAWINGS

FIG. 1 shows an applicator device in the shape of a flash light having a head with a concentration of LED light bulbs;

FIG. 2 shows an applicator in a square configuration;

FIG. 3 shows an applicator in a rectangular configuration;

FIG. 4 is a schematic designed to control certain pulses and intervals.

### DETAILED DESCRIPTION OF THE INVENTION

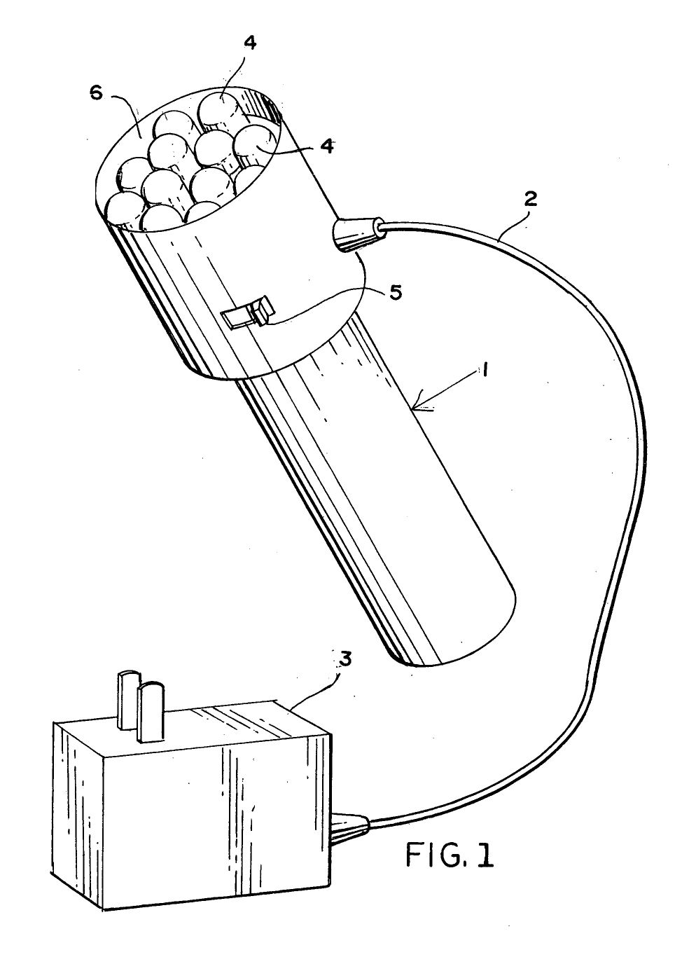

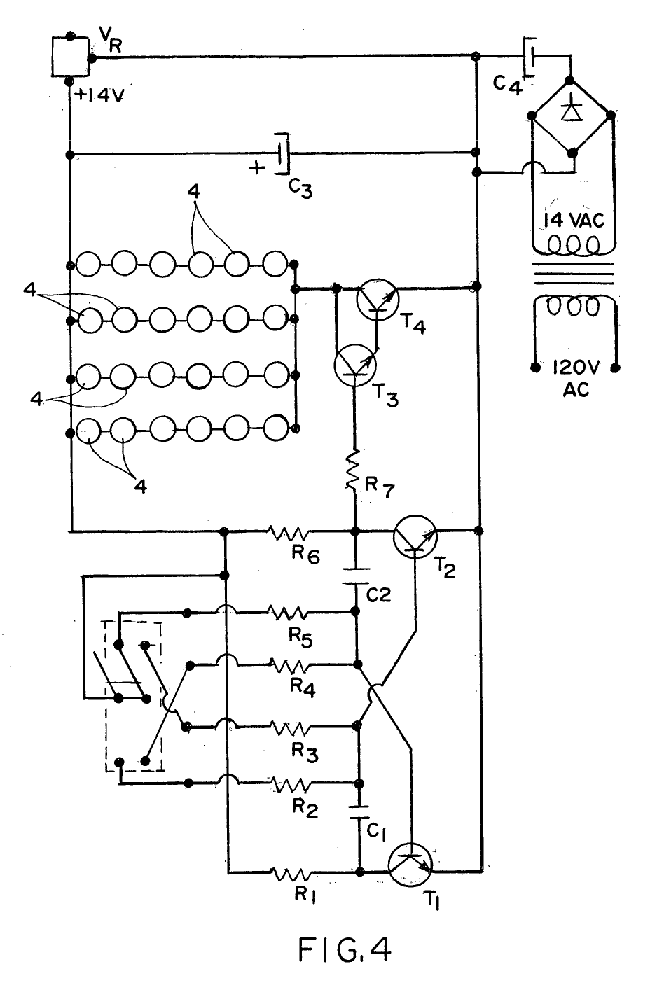

FIG. 1 illustrates a monolight emitting applicator 1 in a round configuration similar to the shape of a flash light. The applicator is attached to an adapter 3 being supplied with 120 VAC which transforms the current to 14-15 VAC. The current from 3 is supplied to the head 6 of the adapter by way of a schematic circuitry shown in FIG. 4. The LED lights 4 in the head of the adapter or somewhat recessed to avoid a direct contact with the skin of a user although no detrimental effects would occur it direct contact would happen. The LED light bulbs 4, in this FIG. 1, are concentrated close to each for reasons to be explained below. The light bulbs have a forward 2.4 +0.3 V, a peak emission wavelength of 660 nm, at 20 mA and have a luminous intensity of 5000 mcd. The applicator device in FIG. 1 consists of 12 LED's in a round surface covering 12 cm² of the circle of the body. The applicator device of FIG. 1 is recommended to be used in the naval, glands of the immune system, the mouth, throat, ears etc. and, all small surfaces where a concentrated light is needed. This is accomplished in FIG. 1 because the LED's are close to each other without any space between them. FIG. 1 also shows a light switch which is not an off-on switch but this switch will change the intensity of the light beams of the light bulbs and will change the time length of the impulses which will be explained below.

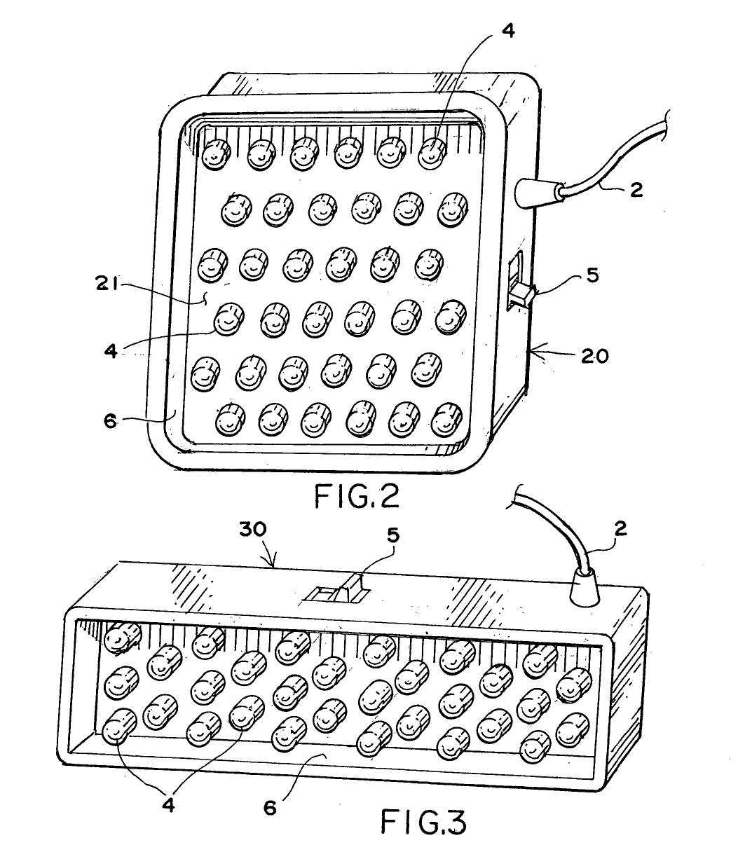

FIG. 2 shows an applicator device 20 in a square configuration. This applicator has 3 LED light bulbs in a square surface of 12 cm×12 cm covering 144 cm² of the body. The same reference characters have been applied as were in FIG. 1. Thus, there is a switch 5 which has the same functions as was explained in FIG. 1. The LED light bulbs are spaced apart farther than they were in FIG. 1. The LED bulbs are mounted on a base plate 21. Again, 6 shows the plate 21 somewhat recessed from the outward rim of the applicator.

This applicator device is recommended for all upper and larger sections of the body and also for the hands and the feet of a human.

FIG. 3 shows the applicator device 30 in a rectangular configuration. Again, the same reference characters have been applied as were in FIGS. 1 and 2. This applicator has 36 LED bulbs on a rectangular surface of 6 cm×25 cm and covers 150 cm² and is recommended for the use on arms and legs.

FIG. 4 is a schematic circuit that operates the massage device. The schematic diagram is used in all of the above described shapes. In all of them, the LED's are connected in groups of six bulbs in series as can be seen from the schematic. Consequently, the round configuration device of FIG. 1 has 2 groups of 6 LED's and the two groups are connected in parallel. The devices of FIGS. 2 and 3 have 6 groups of LED's connected in series and the six groups are connected in parallel.

The voltage supply for all of them is 14 Volts stabilized and, this voltage establishes a current of 20 mA in all LED's. This is one of the main requirements in this inventive concept that all of the LED's operate with a red light having a wavelength of 660 nm.

The switching on and off of the LED's is accomplished by a 266 square impulses per second, which is a second main requirement for the light to pulsate for 266 times per second.

It has been found that the length of time of the square impulse which turn on the LED's has some important impact on the massage effect. For example, a short length of time of the impulse (for example, 200 microseconds) has proven to more effective for a surface massage including about one inch below the skin. The longer length of time of the impulse (for example, 1100 microseconds) is more effective for deeper massages of more than one inch. For this reason, all devices are provided with a switch (see 5 in FIGS. 1-3) which can change the length of time of the LED's which are operating at 266 impulses per second.

All devices are supplied with by a voltage of 14 to 15 VAC through an adapter transformer. This way the user is protected from any electric shocks from the supplied voltage of 120 VAC.

The schematic shown in FIG. 4 includes 3 main stages:
1.) A square impulse generator: T1, T2, R1, R2, R3, R4, R6, C1 and C2. The length of time of the used impulse which turns on the LED's is provided by C1, R2 or C1, R3. The relationship between the length of time of the impulse tl impact and the time constant of the circuit [symbol] or C1R2 or C1R3 is:
   t_{1 imp}= [symbol] /2=C1R2/2 or C1R3/2
   The pulsating of 266 times per second is provided by C2R4 or C2R5, The period of a cycle must be T=1/f=1/266=0.003759 sec. or 3759 microseconds.
   The length of time of the impulse t2 imp which turns off the LED's is:
   t2 imp=T minus tl imp
   Here, one finds the same relationship between the length of time and the time constant:
   t_{2 imp}= [symbol] 2/2=C2R4 or C2R5/2
2.) The electronic switch is provided by a Darlington connection of two transistors T3 and T4. The charge by the groups of 6 LED's in series is connected to the collectors of T₃ and T₄. The emitter of T4 is connected to the ground. The connection of the switch with the output of the square impulse generator is accomplished by a resistor of 470 Kom. This value improves the square shape of the impulse.
3.) The power supply is provided by a fixed voltage regulator of 14 Volt output with an input of 16 to 17 Volt DC. The electrolytic capacitor C4 is 2200 MF filters any kind of impulse coming from the 14 Volt supply or by the generator.

What I claim is:

1. A monolight massage device including led light bulbs, said LED light bulbs are a multiple and are arranged on one surface and at one end of said device and are emitting impulses of light, means for pulsating said emission of light of said LED light bulbs including interruptions of that pulses and means for controlling a length of time between interruptions of said impulses.

2. The massage device of claim 1, wherein said emission of light from said LED lights is in the red color spectrum.

3. The massage device of claim 1, wherein said multiple of LED light bulbs are spaced closely adjacent to each other.

4. The massage device of claim 1, wherein said multiple of LED light bulbs are arranged to be spaced from each other.

5. The massage device of claim 1, wherein said device is of a round configuration.

6. The massage device of claim 1, wherein said device is of a square configuration.

7. The massage device of claim 1 wherein said device is of a rectangular configuration.

8. The massage device of claim 1, wherein said LED light bulbs are pulsing at a pulse of 266 square impulses per second.

9. The massage device of claim 1, wherein the device uses a single wave length monochromatic red light beam of 660 nanometer.

10. The massage device of claim 1, wherein said length of time between interruptions of said impulses is in a range of 200 to 1100 microseconds.

11. The massage device of claim 1 including an electronic circuitry for controlling an operation of said device.
